(19) United States
(12) Patent Application Publication
(10) Pub. No.: US 2011/0236262 A1
(43) Pub. Date: Sep. 29, 2011

(54) BIOLOGICAL SUBSTANCE DETECTING APPARATUS

(75) Inventors: Kazuyoshi HORII, Kanagawa-ken (JP); Tomonari Sendai, Kanagawa-ken (JP); Akihiro Komatsu, Kanagawa-ken (JP); Mitsuaki Uchida, Kanagawa-ken (JP); Masashi Hakamata, Kanagawa-ken (JP); Junpei Shiraishi, Kanagawa-ken (JP); Daisuke Hibe, Kanagawa-ken (JP); Yasunori Ohta, Kanagawa-ken (JP); Akira Ito, Kanagawa-ken (JP)

(73) Assignee: FUJIFILM CORPORATION, Tokyo (JP)

(21) Appl. No.: 13/071,142

(22) Filed: Mar. 24, 2011

(30) Foreign Application Priority Data
Mar. 25, 2010 (JP) 069163/2010
Mar. 23, 2011 (JP) 063492 / 2011

(51) Int. Cl. B01J 19/00

(52) U.S. Cl. 422/69

(57) ABSTRACT

A biological substance detecting apparatus that enables stable detection and quantitative analysis of biologically derived target substances is provided. The biological substance detecting apparatus employs a sensor chip provided with a fine flow channel through which a sample liquid is caused to flow, and a sensor surface that adsorbs a biologically derived target substance. Light is irradiated onto the sensor surface, and light emitted by the adsorbed target substance or a labeling substance bound thereto is detected. A flow speed controlling means, for controlling the flow speed of the sample liquid that flows through the fine flow channel to a value within a range such that the adsorption speed of the target substance is not controlled by dispersion.

### BACKGROUND OF THE INVENTION

1. Field of the Invention

The present invention is related to a biological substance detecting apparatus that detects detection target substances within sample liquids. More specifically, the present invention is related to a biological substance detecting apparatus that employs a sensor chip equipped with a fine flow channel through which sample liquids are caused to flow.

2. Description the Related Art

In biological measurements, the presence or absence and the amounts of antigens (or antibodies), which are detection target substances, are measured by detecting biological molecular reactions, such as antigen antibody reactions.

An example of an immunoassay as a biological measurement method is the sandwich method. In the sandwich method, one of a pair of substances that specifically bind to each other (antigens, antibodies, various enzymes, receptors, etc.) is immobilized onto a substrate, and the other of the pair of substances (this may be the detection target itself, or a competing substance that competes with the detection target substance within a sample) is caused to bind with an immobilized layer immobilized on the substrate. The presence or absence and the amount of the detection target substance within the sample can be measured, by detecting the binding reactions. Specifically, in order to detect antigens, which are detection target substances within a sample, antibodies that specifically bind with the antigens are immobilized on a substrate. Then, the sample is supplied to the substrate to cause specific binding to occur between the antibodies and antigens. Next, labeling antibodies that specifically bind with the antigens are added and caused to bind with the antigens. Thereby, so called sandwiches, each constituted by an antibody-antigen-labeling antibody combination, are formed, and signals from the labels are detected. Another example of an immunoassay is the competitive method. In the competitive method, labeled competing antigens are caused to bind with immobilized antibodies in a competitive manner with antigens, which are detection target substances. Then, signals from labels provided on the competing antigens which have bound to the immobilized antibodies are detected.

Note that in the aforementioned sandwich method, the antigens, which are the detection target substances, corresponds to the “other of the pair of substances”, and that in the competitive method, the competing antigens correspond to the “other of the pair of substances”. In the competitive method, there is a relationship between the competing antigens and the detection target substance that the greater the amount of the competing antigens which have bound with the immobilized antibodies, the lesser the amount of the antigens which are the detection target substance. Therefore, the amount of the detection target substance antigens can be derived from the signal level obtained from the labels that correspond to the amount of the competing antigens.

Fluorometry, which is applicable to biological measurements, is widely used as an easy and highly sensitive measuring method. In fluorometry, a sample, which is considered to contain a detection target substance that emits fluorescence when excited by light having a specific wavelength, is irradiated with an excitation light beam of the aforementioned specific wavelength. The presence of the detection target substance can be confirmed quantitatively by detecting the fluorescence due to the excitation. In the case that the detection target substance is not a fluorescent substance, a substance which is labeled with fluorescent labels and specifically binds with the detection target substance is caused to contact the sample. Thereafter, fluorescence is detected in the same manner as described above, thereby confirming the presence of the detection target substance, by the presence of the bonds.

Further, a method that utilizes the electric field enhancing effect of plasmon resonance in order to improve the sensitivity of fluorometry has been proposed in U.S. Pat. No. 6,194,223. In this surface plasmon enhanced fluorometry method, a metal layer is provided at a predetermined region on a transparent substrate. Excitation light is caused to enter the substrate from the side thereof opposite that on which the metal film is formed, to enter the interface between the substrate and the metal layer at an incident angle greater than or equal to a total reflection angle. Surface plasmon is generated at the metal layer by the excitation light, and fluorescence signals are amplified by the electric field enhancing effects of the surface plasmon, to improve the S/N ratio.

In the biological measurement methods described above, shortening of measurement times is desired. Therefore, various methods for causing reactions on the sensor surface to occur efficiently, thereby shortening measurement times, have been proposed. For example, U.S. Patent Application Publication No. 20090162944 proposes employing a sensor chip having a fine flow channel (micro flow channel) and causing a sample liquid to flow therethrough at a predetermined high speed, to expedite measurements. This type of sensor chip may also be applied to the aforementioned detection and quantitative analysis by fluorometry.

There is room for improvement in conventional biological substance detecting apparatuses that employ the aforementioned fine flow channel type sensor chips to perform detection and quantitative analysis of detection target substances by detecting light, from the viewpoint of stability of detection and quantitative analysis.

### SUMMARY OF THE INVENTION

The present invention has been developed in view of the foregoing circumstances. It is an object of the present invention to provide a biological substance detecting apparatus that enables stable detection and quantitative analysis of detection target substances.

A biological substance detecting apparatus of the present invention employs a sensor chip provided with a fine flow channel through which a sample liquid is caused to flow, a portion of the interior of the fine flow channel being a sensor surface, on which a substance that specifically bonds with one of a detection target substance included in the sample liquid and a competing substance that competes against the detection target substance within the sample liquid is immobilized, and is characterized by comprising:

light irradiating means, for irradiating light onto the sensor surface;

light detecting means, for detecting light emitted by one of the detection target substance bound to the substance immobilized on the sensor surface, the competing substance bound to the substance immobilized on the sensor surface, a labeling substance bound to the detection target substance, and a labeling substance bound to the competing substance; and

flow speed controlling means, for controlling the flow speed of the sample liquid that flows through the fine flow channel to a value within a range such that the speed of binding reactions between one of the detection target substance and the competing substance and the substance immobilized on the sensor surface is not controlled by dispersion.

Note that the flow speed is defined as an average flow speed of the sample liquid which flows through the fine flow channel in a laminar state. It is preferable for the flow speed to be 1.0 mm/sec or greater, more preferably to be within a range from 1.0 mm/sec to 5.0 mm/sec, and most preferably to be within a range from 1.0 mm/sec to 4.7 mm/sec.

The present inventor obtained the following knowledge, as a result of researching the factors that cause loss in stability of detection and quantitative analysis in conventional biological substance detecting apparatuses.

When a detection target substance is captured onto the sensor surface of the aforementioned sensor chip by the antigen antibody reaction, the concentration of the detection target substance within a sample liquid decreases in the vicinity of the sensor surface.

In this case, the reaction speed is controlled by dispersion. At this time, if the sample liquid is flowing through a fine flow channel, new sample liquid will be continuously supplied to the sensor surface. Therefore, decrease in the concentration of the detection target substance within the sample liquid becomes less likely to occur, and the reaction speed being controlled by dispersion is resolved.

However, in the case that the speed of adsorption of the detection target substance onto the sensor surface (binding of the detection target substance with a substance immobilized on the sensor surface) is fast, and flow speed is slow, the supply of the detection target substance cannot keep up with the decrease in the concentration thereof in the vicinity of the sensor surface due to adsorption. In this case, a state in which reaction speed is controlled by dispersion occurs, and reaction speed deteriorates. In addition, in the state that reaction speed is controlled by dispersion, the reaction speed depends on the flow speed, and reactions will be greatly influenced by variations in flow speed. Variations in flow speed may occur by mechanical variations of fluid supply devices such as pumps, and also by variations in ambient temperature and the viscosity of the sample liquid. Therefore, it is extremely difficult to stabilize reaction speed. In addition, in the case that a sample liquid in which preliminary reactions are induced are caused to flow through the flow channel, the sample liquid is not uniform. In such cases, in which the temperature and the viscosity of the sample liquid differ at the initiation and the end of supply thereof, the flow speed fluctuated within a short period of time, and reaction speed becomes unstable. If a state in which reaction speed is controlled by dispersion occurs in this manner, fluctuations in the amount of the detection target substance to be measured become great within speed ranges in which reaction speeds are unstable, even if the flow speed is precisely controlled to be uniform. In addition, the amount of reactions with respect to reaction time becomes a complex mathematical expression in a state in which reaction speed is controlled by dispersion occurs. Therefore, analysis becomes complex, and the quantitative properties may be lost.

Note that the description above is for a case in which a substance that specifically bonds with the detection target substance is immobilized onto the sensor surface. However, the same applies to a case in which a substance that specifically bonds with a competing substance within a sample liquid that competes with the detection target substance is immobilized onto the sensor surface, with respect to adsorption of the competing substance onto the sensor surface (binding with the substance immobilized on the sensor surface).

The biological substance detecting apparatus of the present invention has been developed based on the above knowledge. The biological substance detecting apparatus of the present invention controls the flow speed of the sample liquid that flows through the fine flow channel to a value within a range such that the speed of binding reactions between one of the detection target substance and the competing substance and the substance immobilized on the sensor surface is not controlled by dispersion. Therefore, a stable reaction speed, which is not influenced by external factors, is obtained. Thereby, the apparatus of the present invention enables stable detection or quantitative analysis of detection target substances. In the case that competing antigens are caused to adsorb onto the sensor surface, the competing substance can be stably detected or quantitatively analyzed. As a result, the detection target substance can be stably detected or quantitatively analyzed.

In the case that fluorescent particles, magnetic particles, or magnetic fluorescent particles are employed as the labeling substance, the sizes of these particles are within a range from several tens to several thousand nm. Such labels have smaller dispersion coefficients due to their large sizes compared to case in which fluorescent molecules are employed, and reaction speeds are more likely to be controlled by dispersion. These labeling substances are advantageous in that signals per unit are greater due to their large sizes. However, they also have the drawback that reaction speeds are more likely to be controlled by dispersion.

Accordingly to the present invention, however, because reaction speeds being controlled by dispersion is resolved by flow speed, an advantageous effect that labeling substances having greater sizes than those employed in the standard ELISA method can be utilized.

### BRIEF DESCRIPTION OF THE DRAWINGS

FIG. 1 is a partially sectional diagram that illustrates a biological substance detecting apparatus according to an embodiment of the present invention.

FIG. 2 is a perspective view that illustrates a fine flow channel type sensor chip which is employed by the biological substance detecting apparatus of FIG. 1.

FIG. 3 is a sectional view taken along line 2B-2B of FIG. 2.

FIG. 4 is a plan view that illustrates the fine flow channel type sensor chip of FIG. 2.

FIG. 5 is a diagram for explaining the flow of a sample liquid within a fine flow channel of the fine flow channel type sensor chip of FIG. 2.

FIG. 6 is a graph that illustrates the relationship between the flow speed of sample liquid through the sensor chip of FIG. 2, and the intensity of fluorescence emitted from the sensor chip.

FIG. 7 is a plan view that illustrates another example of a flow channel type sensor chip.

FIG. 8 is a plan view that illustrates yet another example of a flow channel type sensor chip.

FIG. 9 is a diagram for explaining the state during biological substance detection in the sensor chip of FIG. 2.

### DESCRIPTION OF THE PREFERRED EMBODIMENTS

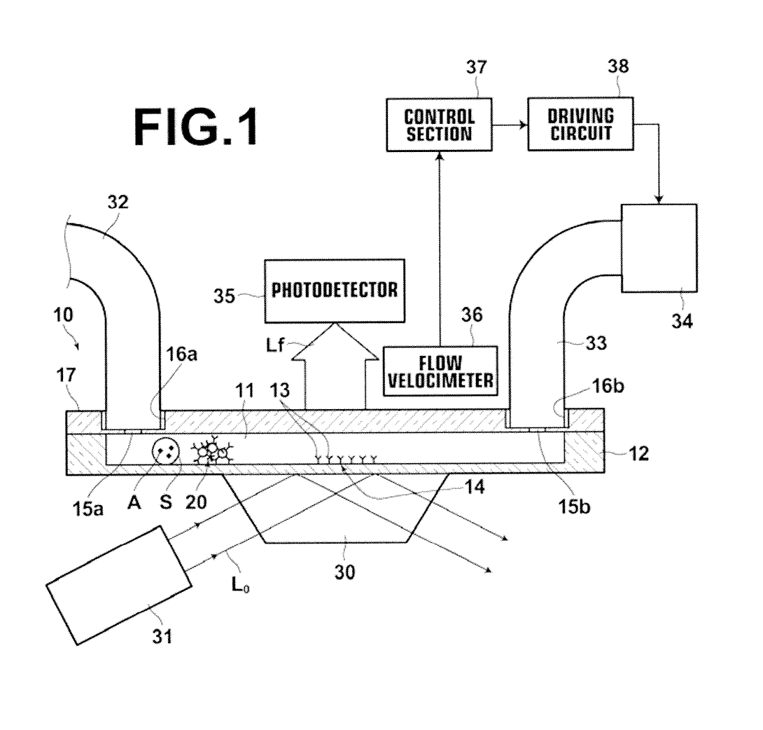

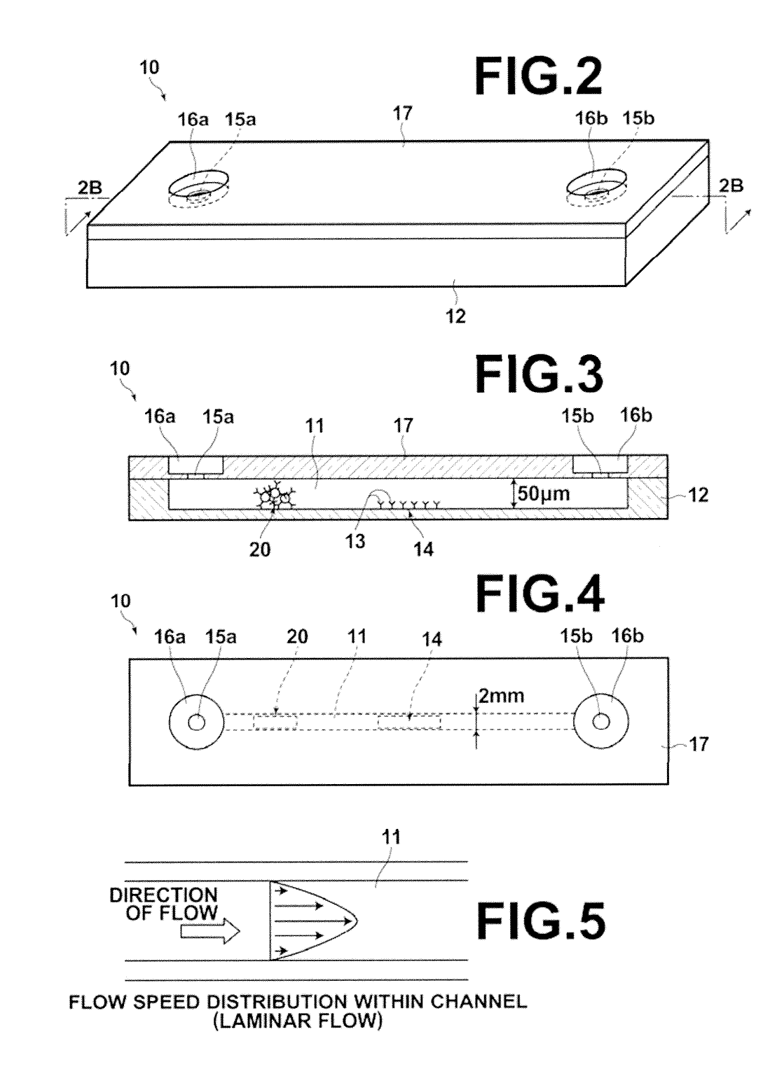

Hereinafter, embodiments of the present invention will be described with reference to the attached drawings. FIG. 1 is a front view of a biological substance detecting apparatus according to an embodiment of the present invention, partially in section. The biological substance detecting apparatus of the present embodiment detects biologically derived substances using a fine flow channel type sensor chip 10 (hereinafter, simply referred to as “sensor chip 10”) of the type described previously. First, the sensor chip 10 will be described with reference to FIGS. 2 through 4.

As illustrated in FIGS. 2 through 4, the sensor chip 10 is equipped with: a flow channel member 12 having a fine flow channel 11 through which a sample liquid is caused to flow; a immobilized layer 14, constituted by one of a pair of substances that specifically bind with each other, formed on the surface of a wall of the fine flow channel 11; and an upper plate member 17 which is fixed on the flow channel member 12. The present embodiment will be described as a case in which an assay is performed by the sandwich method using the antigen antibody reaction. Therefore, a case in which the immobilized layer 14 is constituted by antibodies 13 that specifically bind with antigens A, which are detection target substances, will be described.

Note that the antibodies 13 may be immobilized on the surface of the wall of the fine wall channel 11 directly. However, in the case that fluorescence is to be enhanced by the electric field enhancing effect of surface plasmon as will be described later, a metal film (not shown) is formed on the surface of the wall, and the antibodies 13 are immobilized on the metal film.

The upper plate member 17 has: a sample liquid inlet 16a and a sample liquid outlet 16b which are open at the upper surface; an opening 15a that communicates the sample liquid inlet 16a with the upstream end of the fine flow channel 11; and an opening 15b that communicates the sample liquid outlet 16b with the flow channel 11. The upper plate member 17 and the flow channel member 12 are joined by ultrasonic welding, for example.

The flow channel member 12 and the upper plate member 17 are formed by injection molding and are formed by a transparent dielectric material, such as polystyrene. The dimensions of the fine flow channel 11 are such that the width is 2 mm, and the depth is 50 μm, for example.

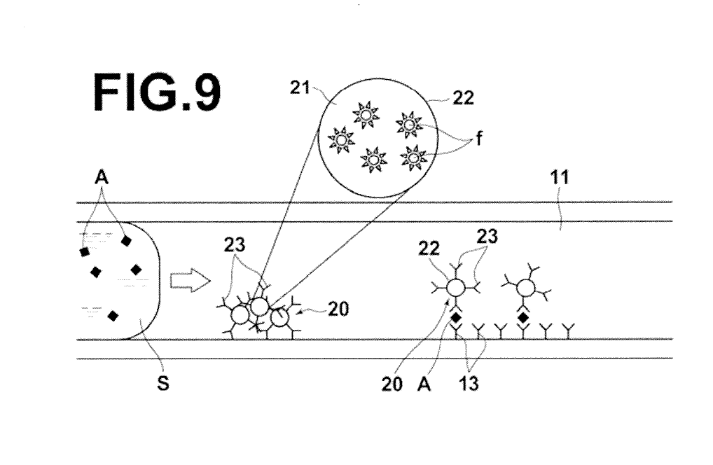

In addition, labeling antibodies 20 are provided on the inner surfaces of the fine flow channels 11 upstream of the region at which the immobilized layer 14 is provided, as illustrated in FIG. 9. The labeling antibodies 20 are constituted by antibodies 23 that specifically bind with the detection target substance at epitopes different from those that the aforementioned antibodies 13 specifically bind with, and fluorescent labels 22. Here, fine fluorescent particles, in which a great number of fluorescent pigment molecules f are enveloped in a light transmissive material 21, are employed as the fluorescent labels 22.

The size of the aforementioned fluorescent particles is not particularly limited. However, it is preferable for the diameters of the fluorescent particles to be within a range from several tens of nm to several hundred nm. In the present embodiment, those having a diameter of 100 nm are employed. Examples of the material of the light transmissive material 21 include polystyrene and SiO₂. However, the material of the light transmissive material 21 is not particularly limited, as long as it is capable of enveloping the fluorescent pigment molecules f and enabling fluorescence emitted by the fluorescent pigment molecules f to pass therethrough toward the exterior. The labeling antibodies 20 of the present embodiment are constituted by the fluorescent labels 22, the surfaces of which are modified with the antibodies 23, which are smaller than the fluorescent labels 22.

Returning to FIG. 1, the biological substance detecting apparatus will be described. The biological substance detecting apparatus is equipped with: a prism 30, on which the sensor chip is placed with refractive index matching oil interposed therebetween; a light source 31 constituted by a semiconductor laser or the like, for emitting excitation light beam L₀ such that it enters the interface between the prism 30 and the sensor chip 10 at an incident angle that satisfies conditions for total reflection; a sample liquid supply pipe 32 which is in communication with the sample liquid inlet 16a of the sensor chip 10; a sample liquid discharge pipe 33, which is in communication with the sample liquid outlet 16b of the sensor chip 10; and a sample suctioning pump 34 connected to the sample liquid discharge pipe 33. Note that the excitation light beam Lₒ is emitted to enter the interface with p polarization, such that surface plasmon is induced.

Further, the biological substance detecting apparatus is equipped with: a photodetector 35, for detecting fluorescence Lf which is generated from the vicinity of the immobilized layer 14 of the sensor chip 10 as will be described later; a flow velocimeter 36, for measuring flow speed of the sample liquid within the fine flow channel 11; a control section 37 that receives the output of the flow velocimeter; and a drive circuit 38, the operations of which are controlled by the control section 37, for driving the sample suctioning pump 34. Note that a laser Doppler flow anemometer, a hot flow meter, a meter that derives flow speed by measuring images of the flow of fluorescent particles within the fine flow channel 11, and the like may be employed as the flow velocimeter 36.

Next, detection of a detection target substance by the biological substance detecting apparatus will be described. Here, a case in which antigens A, which may be included in a sample liquid S (plasma), are detected will be described as an example. First, the sample liquid S is injected into the sample liquid inlet 16a either directly or via the sample liquid supply pipe 32 of FIG. 1. At the same time, the sample suctioning pump 34 is driven, to introduce the sample liquid S into the fine flow channel 11 of the sensor chip 10.

The sample liquid S which is introduced into the fine flow channel 11 mixes with the labeling antibodies 20 which are adsorbed and immobilized within the flow channel 11, as illustrated in FIG. 9. Thereby, the antigens A bind with the antibodies 23 of the labeling antibodies 20. Further, the antigens A which are bound to the antibodies 23 bind with the antibodies 13 of the immobilized layer 14, to form so called sandwiches in which the antigens A are sandwiched between the antibodies 13 and the antibodies 23.

The antigens A which are adsorbed onto the immobilized layer 14 in this manner are detected in the manner described below. The excitation light beam L₀ enters the interface between the prism 30 and the sensor chip 10 at an incident angle that satisfies conditions for total reflection. Evanescent waves seep out into the sample liquid S on the metal film (not shown) provided between the wall of the fine flow channel 11 and the antibodies 13. The evanescent waves excite surface plasmon within the metal film. The surface plasmon generates an electric field distribution on the surface of the metal film, to form an electric field enhancing region.

At this time, if the fluorescent labels 22 are present within the seepage region of the evanescent waves, the fluorescent labels 22 are excited and generate fluorescence Lf. The electric field enhancing effect of surface plasmon, which are present within a region substantially equivalent to the evanescent wave seepage region, amplifies the fluorescence Lf. The photodetector 35 detects the amplified fluorescence Lf. Detecting the presence of the fluorescent labels 22 in this manner is equivalent to detecting the presence of the antigens A, which are bound to the antibodies 13. The presence or absence and the amount of the antigens A can be detected based on the fluorescence detection output of the photodetector 35.

Note that antigens A and labeling antibodies 20 which are not bound with the immobilized antibodies 13 are floating within the fine flow channel 11. In addition, there are labeling antibodies 20 which are non specifically adsorbed on the immobilized layer 14. A cleansing liquid may be introduced into the fine flow channel 11 to remove such antigens A and labeling antibodies 20 prior to detecting the fluorescence Lf.

In the case that a laser beam having a central wavelength of 780 nm is employed as an excitation light beam, and a gold (Au) film is employed as the metal layer 12, a favorable thickness of the metal layer 12 is 50 nm±20 nm. In this case, it is more preferable for the thickness of the metal layer 12 to be 47 nm±10 nm. Note that it is preferable for the metal layer 12a to be a metal having at least one of Au, Ag, Cu, Al, Pt, Ni, Ti, and alloys thereof as a main component.

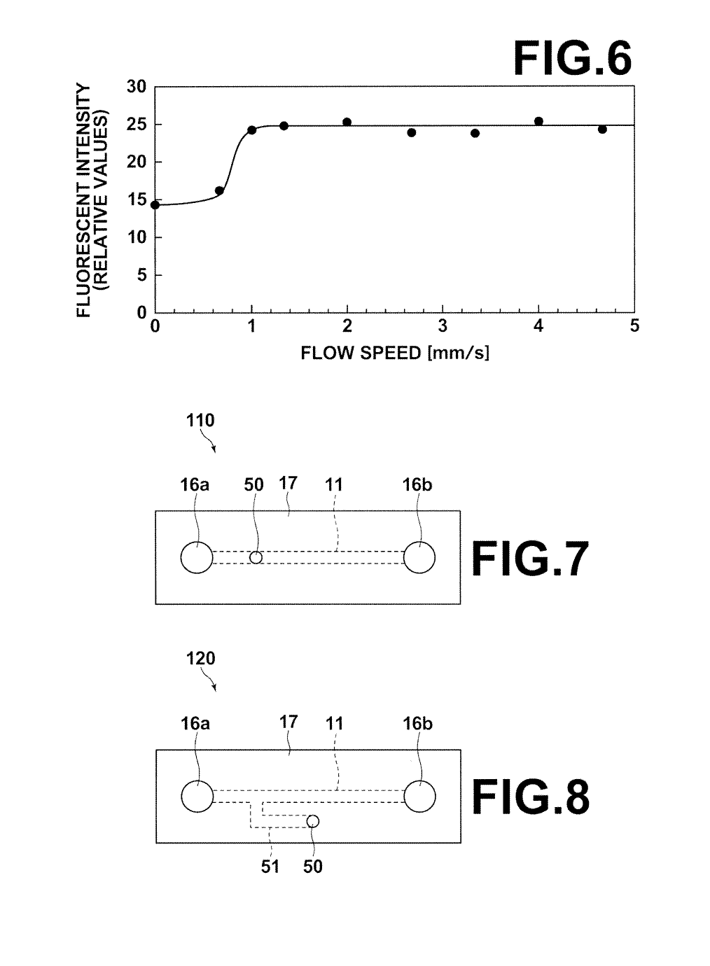

Here, a preferred flow speed of the sample liquid S within the fine flow channel 11 will be described. FIG. 6 is a graph that illustrates the relationship between the flow speed of the sample liquid S, which is plasma having an hCG concentration of 9 pM, and the intensity of fluorescence Lf (corresponding to rate values fo fluorescent signals output from the photodetector 35) emitted after performing an immunoassay. Note that the properties illustrated in FIG. 6 were obtained employing a biological substance detecting apparatus having the basic structure illustrated in FIG. 1. The depth of the fine flow channel 11 of the sensor chip 10 which was utilized was 60 μm, which is the only point in which this sensor chip 10 differs from those illustrated in FIGS. 2 through 4.

As illustrated in FIG. 6, the intensity of fluorescence is stable when the flow speed is within a range from 1.0 mm/sec to 5.0 mm/sec, which indicates a stable reaction speed between the antibodies 13 of the immobilized layer 14 and the antigens A. That is, flow speeds within this range are those at which the speed of adsorption of the antigens A onto the immobilized layer 14 is not controlled by dispersion.

Based on this knowledge, the present embodiment exerts feedback control using the flow velocimeter 36 and the control section 37 illustrated in FIG. 1 such that the flow speed of the sample liquid within the fine flow channel 11 is within a range from 1.0 mm/sec to 5.0 mm/sec. That is, the control section 37 maintains the flow speed of the sample liquid to be within the above range, by controlling the operation of the driving circuit 38 such that the amount of suction applied by the sample suctioning pump 34 is increased if the sample liquid flow speed indicated by the output of the flow velocimeter is a low value of approximately 1.0 mm/sec or slightly greater, and such that the amount of suction applied by the sample suctioning pump 34 is decreased if the sample liquid flow speed indicated by the output of the flow velocimeter is a high value of approximately 5.0 mm/sec or slightly less.

In the present embodiment, the flow speed of the sample liquid S is controlled in this manner. Thereby, stable antigen antibody reaction speeds, which are not influenced by external factors, are realized. Accordingly, the antigens A can be stably detected or quantitatively analyzed.

Here, the flow speed of the sample liquid S is defined as the average flow speed of the sample liquid S which flows through the fine flow channel 11 in a laminar state as described previously. In the case that inspection target substances such as biologically derived blood and urine are handled in microscale measurements such as Lab-on-a-Chip or μ-TAS, such samples generally flow in a laminar manner without turbulence, due to the low Reynolds numbers thereof (Re<200). Laminar flow refers to a state of flow in which flow lines are parallel to the surfaces of the walls of the fine flow channel, the flow speed is fastest at the center of the flow channel, and becomes slower at positions closer to the surfaces of the walls of the flow channel due to friction.

Alternatively, in cases that low concentration detection target substances are to be quantized and longer reaction times are desired in order to increase the amount of reactions in contrast to the example described above, the flow speed may be controlled to be in the vicinity of 1.0 mm/sec without becoming lower than 1.0 mm/sec. Thereby, stable reaction speeds can be maintained over long periods of time.

Note that the flow speed of the sample liquid may be controlled such that it is maintained at a midpoint value within the range from 1.0 mm/sec to 5.0 mm/sec, in addition to maintaining the flow speed to be within the range. In addition, it is particularly preferable for the flow speed to be measured at the sensor surface at which the detection target substance is measured (on the immobilized layer 14 in the present embodiment). However, the flow speed may be measured slightly upstream or downstream from the sensor surface, so as to not hinder measurement of the amount of the detection target substance.

In addition, the biological substance detecting apparatus of the present invention may employ sensor chips other than the sensor chip 10 described above having the sample liquid inlet 16a and the sample liquid outlet 16b at the ends of the fine flow channel 11. Examples of such sensor chips include: a sensor chip 110 as illustrated in FIG. 7, having a pumping air opening 50 provided along the fine flow channel 11; and a sensor chip 120 as illustrated in FIG. 8, having a pumping air opening 50 provided along an air flow channel which is branched from the fine flow channel 11. In the case that these sensor chips 110 and 120 are employed, sample liquids are supplied into the fine flow channels 11 by capillary action, then air is introduced through the pumping air openings 50 to pressurize the sample liquid through the fine flow channel 11.

In addition, in the embodiment described above, the intensity of fluorescence is amplified by utilizing the electric field enhancing effect of surface plasmon. However, the present invention may be applied to cases in which light is irradiated by the standard incident light method. In this case, the previously described metal film need not be formed at the immobilized layer 14.

Further, the detection target substance (analyte) to be detected by the biological substance detecting apparatus of the present invention is not limited as long as it is a biologically derived substance that can be formed as an immobilized layer and observed. Examples of such biologically derived substances include genes and cells, in addition to antigens and antibodies. In the case that genes or cells are to be detected, substances that specifically adsorb to the genes or cells may be immobilized on the inner wall of the fine flow channel. Conversely, it is also possible to detect substances that specifically adsorb to genes and cells with the biological substance detecting apparatus of the present invention. In this case, the genes or cells may be immobilized on the inner wall of the fine flow channel.

In cases that genes, cells, or substances that specifically adsorb thereto are to be detected as well, the preferred range of flow speeds is within 1.0 mm/sec to 5.0 mm/sec. In all of these cases, adsorption occurs due to interactions among proteins. Therefore, a binding speed constant Kₒₙ is approximately 10⁴˜10⁶ (1/Ms). This is because if the speeds at which the analytes are captured by (bound to) the sensor surface are the same, the decrease in concentration of captured particles will be approximately the same. Therefore, the flow speed necessary to resolve reaction speeds being controlled by dispersion will be approximately the same.

In addition, a substance that specifically binds with the detection target substance or with a competing substance within the sample that competes with the detection target substance need not be immobilized directly on the sensor surface. Such a substance may be immobilized via an SAM (Self Assembling Monolayer), a dielectric film such as SiO₂, or a polymer film such as carboxymethyldextran.

The combinations of the substance that specifically binds with the detection target substance or with a competing substance within the sample that competes with the detection target substance are not limited to the antigens and antibodies described above. Examples of other such combinations include substances that bind by reactions utilized in bioassays, such as avidin biotin reactions and enzyme base reactions. The present invention is applicable to these cases as well.

Further, the present invention may be applied to immunoassays performed by the competitive method, in additions to those performed by the sandwich method described above.

In addition, the labeling substance is not limited to fluorescent molecules. Other labeling substances that may be employed include substances that exhibit photoresponsive properties, such as fluorescent beads and fine metal particles.

What is claimed is:

1. A biological substance detecting apparatus that employs a sensor chip provided with a fine flow channel through which a sample liquid is caused to flow, a portion of the interior of the fine flow channel being a sensor surface, on which a substance that specifically bonds with one of a detection target substance included in the sample liquid and a competing substance that competes against the detection target substance within the sample liquid is immobilized, comprising:
light irradiating means, for irradiating light onto the sensor surface;
light detecting means, for detecting light emitted by one of the detection target substance bound to the substance immobilized on the sensor surface, the competing substance bound to the substance immobilized on the sensor surface, a labeling substance bound to the detection target substance, and a labeling substance bound to the competing substance; and
flow speed controlling means, for controlling the flow speed of the sample liquid that flows through the fine flow channel to a value within a range such that the speed of binding reactions between one of the detection target substance and the competing substance and the substance immobilized on the sensor surface is not controlled by dispersion.

2. A biological substance detecting apparatus as defined in claim 1, wherein:
the flow speed is controlled to be 1.0 mm/sec or greater.

3. A biological substance detecting apparatus as defined in claim 2, wherein:
the flow speed is controlled to be within a range from 1.0 mm/sec to 5.0 mm/sec
